(19) United States
(12) Patent Application Publication
(10) Pub. No.: US 2025/0293791 A1
(43) Pub. Date: Sep. 18, 2025

(54) COMMUNICATION CONTROL APPARATUS, COMMUNICATION APPARATUS, COMMUNICATION SYSTEM, STORAGE MEDIUM, AND COMMUNICATION CONTROL METHOD

(71) Applicant: NEC Corporation, Tokyo (JP)

(72) Inventor: Kenji WAKAFUJI, Tokyo (JP)

(73) Assignee: NEC Corporation, Tokyo (JP)

(21) Appl. No.: 19/013,145

(22) Filed: Jan. 8, 2025

(30) Foreign Application Priority Data
Mar. 13, 2024 (JP) 2024-039241

(51) Int. Cl. H04J 14/00; H04J 13/10

(52) U.S. Cl. CPC H04J 14/005; H04J 13/10

(57) ABSTRACT

In order to attain an example object of providing a technique to identify each node while suppressing power consumption even in a case where a plurality of nodes which are free space optical communication partners are located relatively far away, in a case where a pulse width of an optical signal is shorter than a sequence length of a code sequence, in an acquisition process, at least one processor included in a communication control apparatus acquires a first partial sequence which is a part of the code sequence and has been generated while the node is receiving one optical signal, acquires a second partial sequence which is a part of the code sequence and has been generated while the node is receiving another optical signal, and generates the code sequence by joining the second partial sequence to an end of the first partial sequence.

This application is based upon and claims the benefit of priority from Japanese patent application No. Tokugan 2024-039241, filed on Mar. 13, 2024, the disclosure of which is incorporated herein in its entirety by reference.

### TECHNICAL FIELD

The present disclosure relates to a communication control apparatus, a communication apparatus, a communication system, a storage medium, and a communication control method.

### BACKGROUND ART

Various kinds of techniques are known in which a node that serves as a communication partner in free space optical communication is acquired and set to be in a state of being capable of communication. Examples of techniques for acquiring a node include an acquisition and tracking method disclosed in Patent Literature 1. In this acquisition and tracking method, at the time of initial acquisition, pulsed initial acquisition light is generated and transmitted from an optical antenna section in a predetermined path. In a case where reflected initial acquisition light, which is reflected light of the initial acquisition light, has been detected, a detection signal is generated and output. In a case where the detection signal has been output, initial acquisition is shifted to acquisition and tracking.

### CITATION LIST

### Patent Literature

### [Patent Literature 1]

Japanese Patent Application Publication Tokukai No. 2012-156685

### SUMMARY OF INVENTION

### Technical Problem

In order to establish communication with a remote node, it is necessary to increase output of an optical signal. Meanwhile, the increase in output of an optical signal increases power consumption. Therefore, it has been carried out to increase output of an optical signal while suppressing an increase in power consumption by narrowing a pulse width of the optical signal. However, in a case where the pulse width is narrowed, information which is reflected by each node as reflected light and which identifies each node cannot be read. As a result, there is a possibility that each node cannot be identified.

The present disclosure is accomplished in view of the above problem, and an example object thereof is to provide a technique to identify each node while suppressing power consumption even in a case where a plurality of nodes which are free space optical communication partners are located relatively far away.

### Solution to Problem

A communication control apparatus in accordance with an example aspect of the present disclosure includes at least one processor, each of a plurality of nodes to be identified being configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received, the at least one processor carrying out an acquisition process of acquiring a code sequence which has been reflected by any of the plurality of nodes, a demodulation process of demodulating the code sequence using any of the spreading codes, and an identification process of identifying, among the plurality of nodes, a node that corresponds to the spreading code which has been used in the demodulation, in a case where a pulse width of the optical signal is shorter than a sequence length of the code sequence, in the acquisition process, the at least one processor acquiring a first partial sequence which is a part of the code sequence and has been generated while the node is receiving one optical signal, acquiring a second partial sequence which is a part of the code sequence, is continued from the first partial sequence, and has been generated while the node is receiving another optical signal, and generating the code sequence by joining the second partial sequence to an end of the first partial sequence.

A communication apparatus in accordance with an example aspect of the present disclosure includes: the above described communication control apparatus; a light emission section which repeatedly emits the optical signal in a predetermined cycle; and a light reception section which receives the code sequence, the predetermined cycle being set to a time obtained by adding the pulse width of the optical signal to a time which is an integral multiple of the sequence length.

A communication system in accordance with an example aspect of the present disclosure includes: a plurality of nodes each of which is configured to (i) repeat a modulation action for modulating received light into a code sequence using any of spreading codes having different patterns and (ii) reflect at least a part of the code sequence which has been generated by at least a part of the modulation action carried out while a pulsed optical signal is being received; and the above described communication control apparatus or the above described communication apparatus.

A non-transitory storage medium in accordance with an example aspect of the present disclosure stores a communication control program for causing at least one processor to carry out: an acquisition process of acquiring a code sequence which has been reflected by any of a plurality of nodes each of which is configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received; a demodulation process of demodulating the code sequence using any of the spreading codes; and an identification process of identifying, among the plurality of nodes, a node that corresponds to the spreading code which has been used in the demodulation, in a case where a pulse width of the optical signal is shorter than a sequence length of the code sequence, the at least one processor, in the acquisition process, being caused to further carry out a process of acquiring a first partial sequence which is a part of the code sequence and has been generated while the node is receiving one optical signal, a process of acquiring a second partial sequence which is a part of the code sequence, is continued from the first partial sequence, and has been generated while the node is receiving another optical signal, and a process of generating the code sequence by joining the second partial sequence to an end of the first partial sequence.

A communication control method in accordance with an example aspect of the present disclosure includes: acquiring, by at least one processor, a code sequence which has been reflected by any of a plurality of nodes each of which is configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received; demodulating, by the at least one processor, the code sequence using any of the spreading codes; and identifying, by the at least one processor, among the plurality of nodes, a node that corresponds to the spreading code which has been used in the demodulation, in a case where a pulse width of the optical signal is shorter than a sequence length of the code sequence, in the acquiring, the at least one processor acquiring a first partial sequence which is a part of the code sequence and has been generated while the node is receiving one optical signal, acquiring a second partial sequence which is a part of the code sequence, is continued from the first partial sequence, and has been generated while the node is receiving another optical signal, and generating the code sequence by joining the second partial sequence to an end of the first partial sequence.

### Advantageous Effects of Invention

According to an example aspect of the present disclosure, it is possible to identify each node while suppressing power consumption even in a case where a plurality of nodes which are free space optical communication partners are located relatively far away.

### BRIEF DESCRIPTION OF DRAWINGS

FIG. 1 is a block diagram illustrating an example of a functional configuration of a communication control apparatus in accordance with a first example embodiment of the present disclosure.

FIG. 2 is a diagram illustrating an example of a node to be identified by the communication control apparatus.

FIG. 3 is a diagram for describing acquisition of a code sequence by the communication control apparatus in a case where a pulse width of an optical signal is not shorter than a sequence length of the code sequence.

FIG. 4 is a diagram for describing acquisition of a code sequence by the communication control apparatus in a case where a pulse width of an optical signal is shorter than a sequence length of the code sequence.

FIG. 5 is a flowchart illustrating an example of a flow of a communication control method in accordance with the present disclosure.

FIG. 6 is a block diagram illustrating an example of a node which is to be identified by a communication control apparatus in accordance with a second example embodiment of the present disclosure.

FIG. 7 is a diagram for describing modulation of an optical signal carried out in the node.

FIG. 8 is a block diagram illustrating a functional configuration of the communication control apparatus.

FIG. 9 is a diagram for describing an example of acquisition of a code sequence by the communication control apparatus in a case where a pulse width of an optical signal is shorter than a sequence length of the code sequence.

FIG. 10 is a diagram for describing another example of acquisition of a code sequence by the communication control apparatus in a case where a pulse width of an optical signal is shorter than a sequence length of the code sequence.

FIG. 11 is a flowchart illustrating an example of a flow of a communication control method in accordance with the second example embodiment of the present disclosure.

FIG. 12 is a block diagram illustrating an example of a functional configuration of a communication apparatus in accordance with a third example embodiment of the present disclosure.

FIG. 13 is a block diagram illustrating a schematic configuration of a communication system in accordance with a fourth example embodiment of the present disclosure.

FIG. 14 is a block diagram illustrating a hardware configuration of a computer which functions as a communication control apparatus in accordance with the present disclosure.

### EXAMPLE EMBODIMENTS

The following description will discuss example embodiments of the present invention. The present invention is not limited to the example embodiments below, but may be altered in various ways by a skilled person within the scope of the claims. For example, the present invention can also encompass, in its scope, any example embodiment derived by appropriately combining technical means employed in the example embodiments described below. Alternatively, the present invention can also encompass, in its scope, any example embodiment derived by appropriately omitting part of technical means employed in the example embodiments described below. The example advantages described in each of the example embodiments below are example advantages expected in that example embodiment, and do not define an extension of the present invention. That is, the present invention can also encompass, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Node 2)

Before describing a communication control apparatus 1, the following description will discuss, with reference to FIG. 2, a configuration of a node 2 which is to be identified by the communication control apparatus 1. The node 2 is an apparatus that communicates with a communication apparatus 3 described later. The node 2 may be an apparatus that is fixed at a predetermined location, or may be a moving object (e.g., a vehicle, an unmanned aerial vehicle (UAV), or the like) Each of a plurality of nodes 2 to be identified repeats a modulation action for modulating received light into a code sequence using any of spreading codes having patterns which differ for each of the plurality of nodes. Furthermore, each of the nodes 2 is configured to reflect at least a part of the code sequence (i.e., a modulated optical signal) which has been generated by at least a part of the modulation action carried out while a pulsed optical signal is being received.

### (Configuration of Communication Control Apparatus 1)

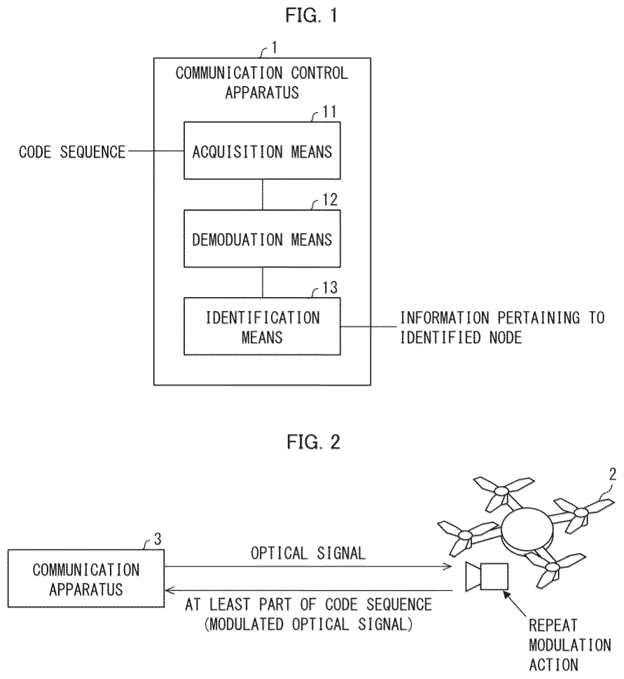

The following description will discuss a configuration of the communication control apparatus 1, with reference to FIG. 1. FIG. 1 is a block diagram illustrating the configuration of the communication control apparatus 1. The communication control apparatus 1 is an apparatus that identifies a plurality of nodes 2. As illustrated in FIG. 1, the communication control apparatus 1 includes an acquisition means 11, a demodulation means 12, and an identification means 13.

### Acquisition Means

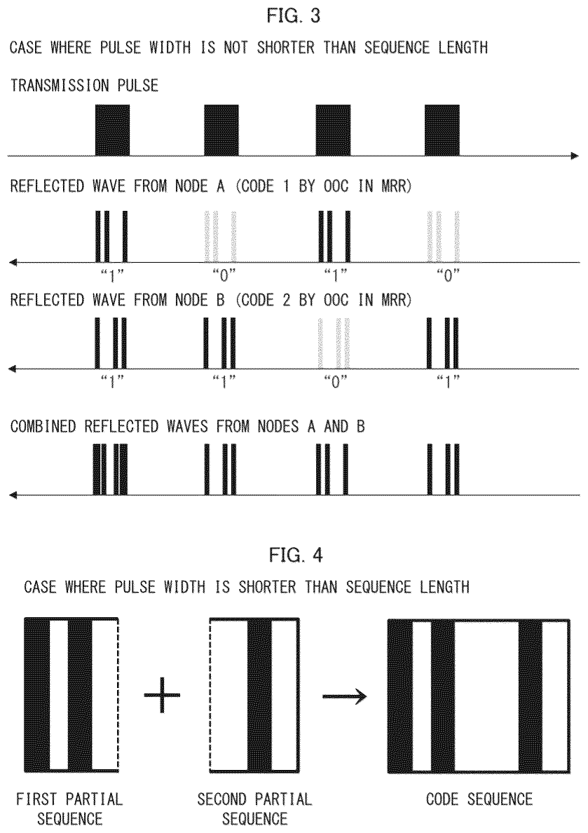

The acquisition means 11 acquires a code sequence which has been reflected by any of the plurality of nodes 2. In a case where a pulse width of an optical signal is not shorter than a sequence length of the code sequence, the entire single code sequence reaches a light reception section as illustrated in FIG. 3. Therefore, the acquisition means 11 can acquire the code sequence at a time.

Meanwhile, a pulse width of an optical signal may be shorter than a sequence length of a code sequence. In such a case, the single code sequence cannot entirely reach the light reception section. In this case, the acquisition means 11 acquires a first partial sequence as illustrated in FIG. 4. The first partial sequence is a part of the code sequence and has been generated while the node 2 is receiving one optical signal. Moreover, the acquisition means 11 acquires a second partial sequence. The second partial sequence is a part of the code sequence continued from the first partial sequence and has been reflected while the node 2 is receiving another optical signal. Then, the acquisition means 11 joins the second partial sequence to an end of the acquired first partial sequence to generate the code sequence.

### Demodulation Means

The demodulation means 12 demodulates a code sequence using any of spreading codes having patterns which differ for each of the nodes. In a case where a spreading code that has been used for modulation by a node 2, which has reflected the acquired code sequence, is used in this demodulation, codes are gathered at a predetermined pulse position to become the original optical signal. Meanwhile, in a case where a spreading code different from the spreading code that has been used for modulation by a node 2, which has reflected the acquired code sequence, is used in this demodulation, codes are dispersed to become a noise.

### Identification Means

The identification means 13 identifies, among the plurality of nodes 2, a node 2 which corresponds to a spreading code which has been used in demodulation. That is, the identification means 13 identifies a node 2 which has reflected a code sequence returned to an original optical signal by demodulation. The identification means 13 then outputs information pertaining to the identified node 2. The information is transmitted to, for example, a communication apparatus 3 (described later). Thus, the communication apparatus 3 can recognize the identified node as a communication partner.

### (Example Advantage of Communication Control Apparatus 1)

The communication control apparatus 1 described above employs the configuration in which, in a case where a pulse width of an optical signal is shorter than a sequence length of a code sequence, the acquisition means 11 acquires a first partial sequence and a second partial sequence. Moreover, the communication control apparatus 1 employs the configuration in which the acquisition means 11 generates the code sequence by joining the second partial sequence to an end of the first partial sequence. That is, in a case where the pulse width of the optical signal is shorter than the sequence length of the code sequence, the communication control apparatus 1 acquires the code sequence in a plurality of portions. Therefore, the communication control apparatus 1 in accordance with the present example embodiment brings about an example advantage of making it possible to identify each node 2 while suppressing power consumption even in a case where a plurality of nodes 2 which are free space optical communication partners are located relatively far away.

### (Flow of Communication Control Method)

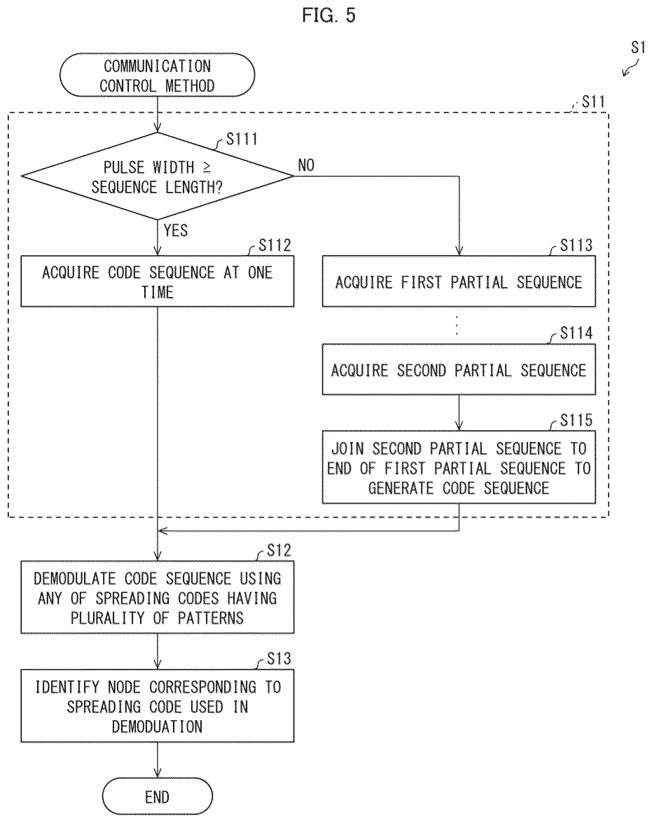

The following description will discuss a flow of a communication control method S1, with reference to FIG. 5. FIG. 5 is a flowchart illustrating a flow of the communication control method. The communication control method S1 is a method for identifying a plurality of nodes 2. Here, each of the plurality of nodes 2 to be identified is identical with those described in “Configuration of node 2” above. As illustrated in FIG. 5, the communication control method S1 includes an acquisition process S11, a demodulation process S12, and an identification process S13. The acquisition process S11 includes a determination process S111, an entirety acquisition process S112, a first part acquisition process S113, a second part acquisition process S114, and a joining process S115.

### Acquisition Process

First, in the acquisition process S11, a computer acquires a code sequence which has been reflected by any of a plurality of nodes. A computer used in the acquisition process S11 may be the foregoing communication control apparatus 1 or may be another apparatus. In the acquisition process S11, first, the determination process S111 is carried out. In the determination process S111, in a case where it has been determined that a pulse width of an optical signal is not shorter than a sequence length of the code sequence (S111: YES), the process proceeds to the entirety acquisition process S112. In the entirety acquisition process S112, the computer acquires the code sequence at one time.

In the determination process S111, in a case where it has been determined that a pulse width of an optical signal is shorter than a sequence length of the code sequence (S111: NO), the process proceeds to the first part acquisition process S113. In the first part acquisition process S113, the computer acquires a first partial sequence. After the first partial sequence is acquired, the process proceeds to the second part acquisition process S114. In the second part acquisition process S114, the computer acquires a second partial sequence. An order in which the computer acquires partial sequences is not particularly limited. That is, the first partial sequence may be acquired after the second partial sequence is acquired. After the first partial sequence and the second partial sequence are acquired, the process proceeds to the joining process S115. In the joining process S115, the computer joins the second partial sequence to an end of the first partial sequence to generate the code sequence.

### Demodulation Process

After the code sequence is acquired, the process proceeds to the demodulation process S12. In the demodulation process S12, the computer demodulates a code sequence using any of spreading codes having patterns which differ for each of the nodes. A computer used in the demodulation process S12 may be the foregoing communication control apparatus 1 or may be another apparatus.

### Identification Process

After the code sequence is demodulated, the process proceeds to the identification process S13. In the identification process S13, the computer identifies, among the plurality of nodes 2, a node 2 which corresponds to a spreading code which has been used in demodulation. A computer used in the identification process S13 may be the foregoing communication control apparatus 1 or may be another apparatus. The computer used in the identification process S13 may be identical with or different from the computer used in the acquisition process S11 and the demodulation process S12 described above.

### (Example Advantage of Communication Control Method)

As described above, the communication control method S1 employs the configuration in which, in a case where a pulse width of an optical signal is shorter than a sequence length of a code sequence, in the acquisition process S11, a first partial sequence and a second partial sequence are acquired. Moreover, the communication control method S1 employs the configuration in which, in the acquisition process S11, the code sequence is generated by joining the second partial sequence to an end of the first partial sequence. That is, in a case where the pulse width of the optical signal is shorter than the sequence length of the code sequence, in the communication control method S1, the code sequence is acquired in a plurality of portions. Therefore, the communication control method S1 in accordance with the present example embodiment brings about an example advantage of making it possible to identify each node 2 while suppressing power consumption even in a case where a plurality of nodes 2 which are free space optical communication partners are located relatively far away.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Node 2)

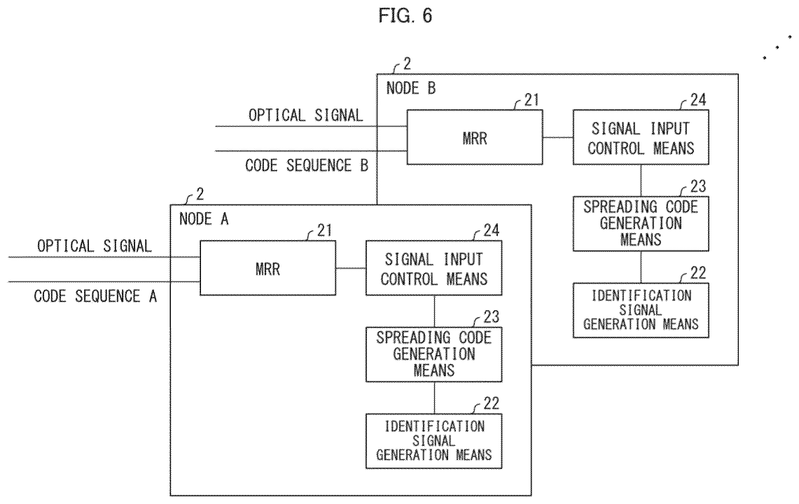

Before describing a communication control apparatus 1A, the following description will discuss, with reference to FIG. 6, a configuration of a node 2 which is to be identified by the communication control apparatus 1A. FIG. 6 is a block diagram illustrating a configuration of the node 2. In FIG. 6, only a node A and a node B among a plurality of nodes 2 are illustrated. As illustrated in FIG. 6, the node 2 in accordance with the present example embodiment includes a modulating retro reflector (hereinafter “MRR 21”), an identification signal generation means 22, a spreading code generation means 23, and a signal input control means 24.

The MRR 21 repeats a modulation action. Then, the MRR 21 reflects, against a direction in which an optical signal has come, at least a part of a code sequence which has been generated by at least a part of the modulation action carried out while the optical signal is being received.

The identification signal generation means 22 generates identification signals which differ for each of the nodes 2.

The spreading code generation means 23 generates a spreading code that corresponds to an identification signal. The spreading code which is used by the node 2 in accordance with the present example embodiment is an optical orthogonal code. Note that the spreading code may be a prime sequence code, an extended prime sequence code, or the like.

The signal input control means 24 controls the MRR 21 so that the MRR 21 carries out a modulation action corresponding to the spreading code which has been generated by the spreading code generation means 23. As described above, identification signals differ for each of the nodes 2. Optical orthogonal codes generated based on the different identification signals and modulation actions of the MRR 21 corresponding to the optical orthogonal codes differ for each of the nodes 2.

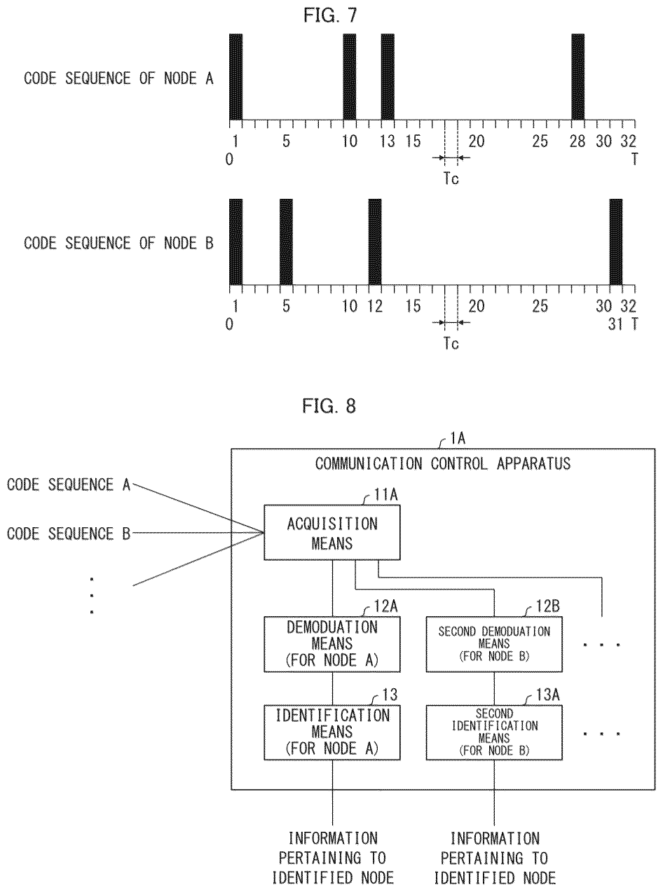

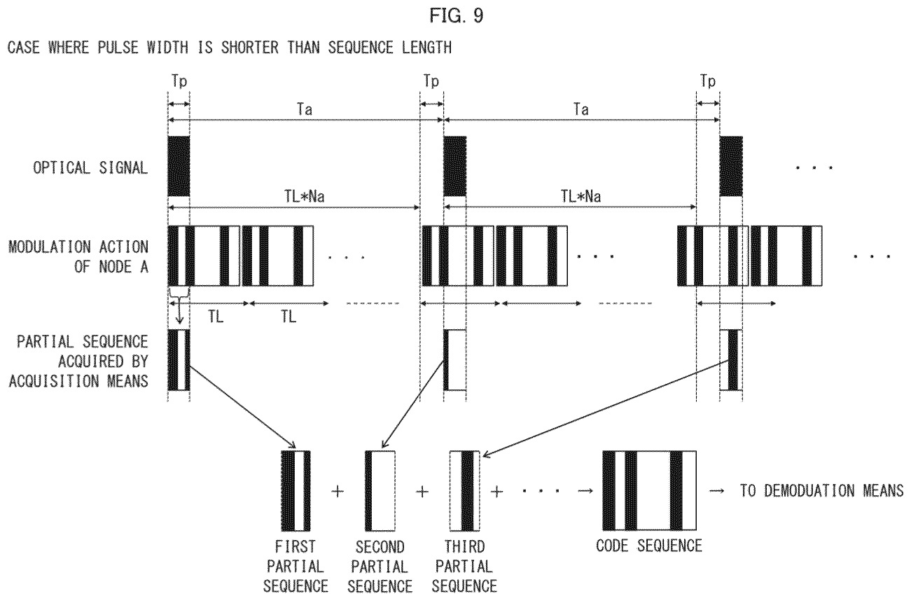

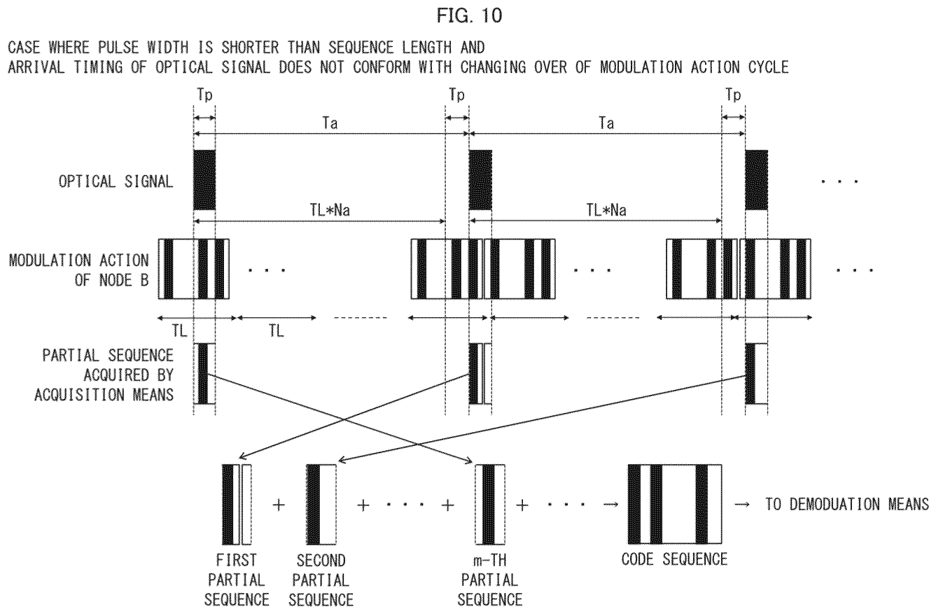

In the node 2 thus configured, the MRR 21 repeats the modulation action (on-off keying (OOK)) on the basis of control by the signal input control means 24. An MRR 21 of one node 2 (node A) generates a code sequence having a pattern in which a sequence of On and Off is as illustrated in, for example, the upper part of FIG. 7. An MRR 21 of another node (node B) generates a code sequence having a sequence pattern of On and Off (as illustrated in, for example, the lower part of FIG. 7) which is different from that of the one node 2 because the signal input control means 24 refers to a different spreading code. Note that the nodes 2 are not synchronized. That is, the nodes 2 independently carry out respective modulation actions. Therefore, change-over timings of cycles of modulation actions carried out by the respective nodes 2 are usually not identical with each other. Therefore, partial sequences which are acquired by an acquisition means 11A (described later) and which correspond to optical signals transmitted at the same timing are not necessarily the same portion (e.g., the leading portion) in the code sequence (see FIGS. 9 and 10).

### (Configuration of Communication Control Apparatus 1A)

The following description will discuss a configuration of the communication control apparatus 1A, with reference to FIG. 8. FIG. 8 is a block diagram illustrating the configuration of the communication control apparatus 1A. As illustrated in FIG. 8, the communication control apparatus 1A in accordance with the present example embodiment includes an acquisition means 11A, a demodulation means 12A, a second demodulation means 12B, and a second identification means 13A, in addition to an identification means 13 similar to that in the communication control apparatus 1 in accordance with the first example embodiment. Note that the communication control apparatus 1A may further include third through n-th demodulation means and third through n-th identification means.

### Acquisition Means

The acquisition means 11A in accordance with the present example embodiment acquires a plurality of code sequences which have been reflected by a plurality of nodes, respectively. In a case where a pulse width of an optical signal is shorter than a sequence length of the code sequence, the acquisition means 11A acquires a first partial sequence and a second partial sequence. Specifically, as illustrated in FIG. 9, the acquisition means 11A acquires the first partial sequence which is a part of the code sequence and which has been generated by a modulation action carried out while the node 2 is receiving a first optical signal. Then, the acquisition means 11 acquires the second partial sequence which is a part of the code sequence and which has been generated by a modulation action carried out while a second optical signal is being received. Then, the acquisition means 11A joins the second partial sequence to an end of the acquired first partial sequence to generate the code sequence. In a case where the pulse width of the optical signal is still shorter than the sequence length of the code sequence (the pulse width is 1/m of the sequence length), the acquisition means 11A in accordance with the present example embodiment acquires, in addition to the first and second partial sequences, third through m-th partial sequences. The m-th partial sequence is a part of the code sequence continued from an (m−1)th partial sequence and has been reflected while the node 2 is receiving an optical signal. In this case, the acquisition means 11A combines the acquired first through m-th partial sequences to generate the code sequence.

The communication control apparatus 1A is not synchronized with the nodes 2. Therefore, the optical signal does not necessarily reach the node 2 at the same time as the timing at which the modulation action of the node 2 changes over to the next cycle (i.e., a partial sequence which is reflected first is not necessarily a partial sequence starting from the beginning). In this case, as illustrated in FIG. 10, the acquisition means 11A acquires m-th, (m+1)th, . . . partial sequences which are each an intermediate part of the code sequence and which have been generated by modulation actions carried out while the node 2 is receiving first, second, . . . optical signals. The node 2 repeats the modulation action. Therefore, the cycle of the modulation action of the node 2 changes over while an optical signal is being received at a certain timing (or at the same time as arrival). A part which has been generated at this timing and includes the beginning of the code sequence is acquired as a first partial sequence. Then, the acquisition means 11A combines acquired partial sequences in order from the first partial sequence, and thus generates the code sequence.

### Demodulation Means

The demodulation means 12A demodulates a plurality of code sequences using any of spreading codes having patterns which differ for each of the nodes. Thus, among the plurality of code sequences, only in a code sequence which has been modulated by a spreading code that is identical with that used for demodulation, codes are gathered at predetermined pulse positions to become the original optical signal. Meanwhile, in the other code sequences which have been modulated by spreading codes different from that used in demodulation, codes are dispersed to become a noise.

Second Demodulation Means, n-th Demodulation Means

The second demodulation means 12B demodulates each of code sequences using another spreading code which is different from a spreading code which has been used by the demodulation means 12 among spreading codes having a plurality of patterns. Thus, a code sequence different from a code sequence which has been demodulated by the demodulation means 12 into an optical signal is demodulated into an optical signal. The n-th demodulation means demodulates each of the code sequences using another spreading code which is different from spreading codes which have been used by the demodulation means 12 through an (n−1)th demodulation means among the spreading codes having the plurality of patterns.

Note that, in a case where a distance between a transmission point and each of the nodes 2 differs, a near-far problem occurs which is peculiar to code division multiple access (CDMA) communication. That is, a signal reaching from a farther node 2 receives interference from a signal generated by a nearer node 2. Therefore, the demodulation means and the second through n-th demodulation means in accordance with the present example embodiment each refer to a spreading code of another node 2, and thus demodulate not only a code sequence of an intended (farther) node 2 but also a code sequence of another (nearer) node 2 in parallel. Then, the demodulation means and the second through n-th demodulation means each remove the influence of interference by subtracting the code sequence of that another node 2 from the code sequence of the intended node 2.

In a case where the node 2 moves, a deviation occurs in a timing of reflection. Assuming that a frequency of ON and OFF for pointing is 10 MHz, a 1-chip time of a spread signal is 10-7 s=0.1 μs. That is, the node 2 moving toward the transmission point at 100 km/h approaches the transmission point by 28 mm (56 mm in a round trip) while 1 ms elapses. A time for light to make a round trip this distance is approximately 0.2 ns. However, this round-trip time is sufficiently shorter with respect to 0.1 μs for 1 chip. Therefore, interference caused by movement of the node 2 is negligible.

Second Identification Means, n-th Identification Means

The second identification means 13A identifies, among the plurality of nodes 2, a node 2 which corresponds to a spreading code which has been used in demodulation by the second demodulation means 12B. Thus, a node 2 is identified which is different from the node 2 identified by the identification means 13. The n-th identification means identifies a node 2 which corresponds to a spreading code which has been used in demodulation by the n-th demodulation means.

### (Example Advantage of Communication Control Apparatus 1A)

According to the communication control apparatus 1A described above, an example advantage similar to that of the communication control apparatus 1 in accordance with the first example embodiment can be brought about. That is, the communication control apparatus 1A brings about an example advantage of making it possible to identify each node 2 while suppressing power consumption even in a case where a plurality of nodes 2 which are free space optical communication partners are located relatively far away. Moreover, the communication control apparatus 1A described above employs the configuration in which the second demodulation means 12B demodulates each of code sequences using another spreading code different from that used by the demodulation means 12. Moreover, the communication control apparatus 1A employs the configuration in which the second identification means 13A identifies, among the plurality of nodes 2, a node 2 which corresponds to a spreading code which has been used in demodulation by the second demodulation means 12B. Therefore, the communication control apparatus 1A brings about an example advantage of making it possible to establish communications with the plurality of nodes 2 in parallel.

### (Flow of Communication Control Method)

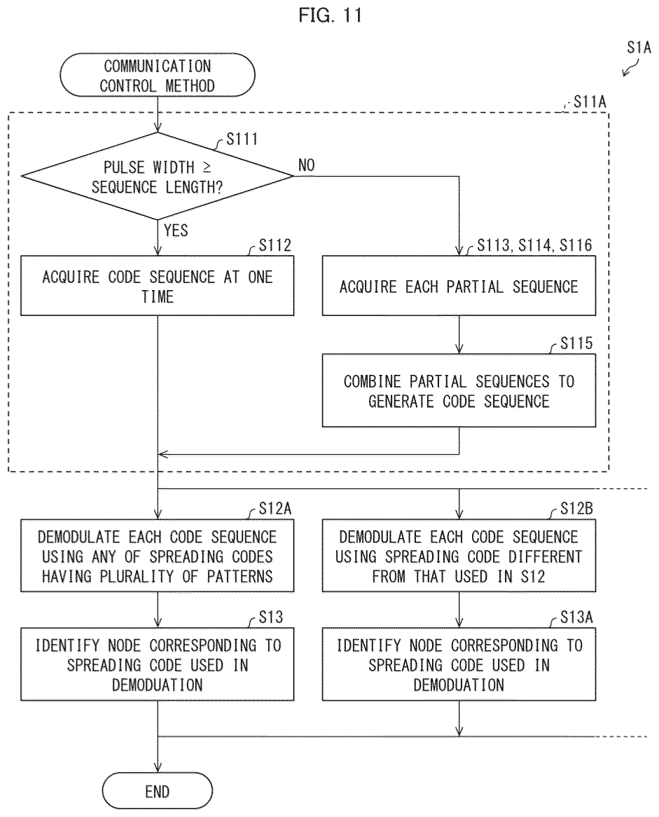

The following description will discuss a flow of a communication control method S1A, with reference to FIG. 11. FIG. 11 is a flowchart illustrating a flow of the communication control method. The communication control method S1A is a method for identifying a plurality of nodes 2. Here, each of the plurality of nodes 2 to be identified is similar to the node 2 to be identified by the communication control apparatus 1 in accordance with the first example embodiment. As illustrated in FIG. 11, the communication control method S1A includes, in addition to the identification process S13 in the communication control method S1 in accordance with the first example embodiment, an acquisition process S11A, a demodulation process S12A, a second demodulation process S12B, and a second identification process S13A. Note that the communication control method S1A may further include third through n-th demodulation processes and third through n-th identification processes. In addition to a first part acquisition process S113 and a second part acquisition process S114, the acquisition process S11A may further include third through n-th part acquisition processes.

### Acquisition Process

First, in the acquisition process S11A, a computer acquires a plurality of code sequences which have been reflected by a plurality of nodes, respectively. In a case where a pulse width of an optical signal is shorter than a sequence length of a code sequence, a first partial sequence and a second partial sequence are acquired in the first part acquisition process S113 and the second part acquisition process S114, respectively. In the acquisition process S11A in accordance with the present example embodiment, in a case where the pulse width of the optical signal is still shorter than the sequence length of the code sequence (the pulse width is 1/m of the sequence length), the process proceeds to an additional part acquisition process S116 after the second part acquisition process S114. In the additional part acquisition process S116, the computer further acquires third through m-th partial sequences. In this case, in the joining process S115, the code sequence is generated by combining the acquired first through m-th partial sequences.

### Demodulation Process

After the plurality of code sequences are acquired, the process proceeds to the demodulation process S12A. In the demodulation process S12A, the computer demodulates the plurality of code sequences using any of spreading codes having patterns which differ for each of the nodes.

### Second Demodulation Process

After the code sequence is acquired, the process proceeds to the second demodulation process S12B. In the second demodulation process S12B, the computer demodulates each of the code sequences using, among spreading codes having a plurality of patterns, another spreading code which is different from that used in the demodulation process S12. Thus, a code sequence different from the code sequence which has been demodulated into an optical signal in the demodulation process S12 is demodulated into an optical signal. Note that the second demodulation process S12B may be carried out before the demodulation process S12 or may be carried out in parallel with the demodulation process S12.

### Second Identification Process

After the code sequence is demodulated, the process proceeds to the second identification process S13A. In the second identification process S13A, the computer identifies, among the plurality of nodes 2, a node 2 which corresponds to a spreading code which has been used in demodulation in the second demodulation process S12B. Thus, a node 2 is identified which is different from the node 2 identified in the identification process S13. Note that the second identification process S13A may be carried out before the identification process S13 or may be carried out in parallel with the identification process S13.

### (Example Advantage of Communication Control Method)

According to the communication control method S1A described above, an example advantage similar to that of the communication control method S1 in accordance with the first example embodiment can be brought about. That is, the communication control method S1A brings about an example advantage of making it possible to identify each node 2 while suppressing power consumption even in a case where a plurality of nodes 2 which are free space optical communication partners are located relatively far away. Moreover, the communication control method S1A described above employs the configuration in which, in the second demodulation process S12B, each of code sequences is demodulated using another spreading code different from that used by the demodulation means 12. Moreover, the communication control method S1A employs the configuration in which, in the second identification process S13A, among the plurality of nodes 2, a node 2 that corresponds to a spreading code which has been used in demodulation in the second demodulation process S12B is identified. Therefore, the communication control method S1A brings about an example advantage of making it possible to establish communications with the plurality of nodes 2 in parallel.

### Third Example Embodiment

The following description will discuss a third example embodiment, which is an example of an embodiment of the present invention, in detail, with reference to the drawings. The same reference numerals are given to constituent elements having the same functions as those described in the foregoing example embodiments, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Communication Apparatus 3)

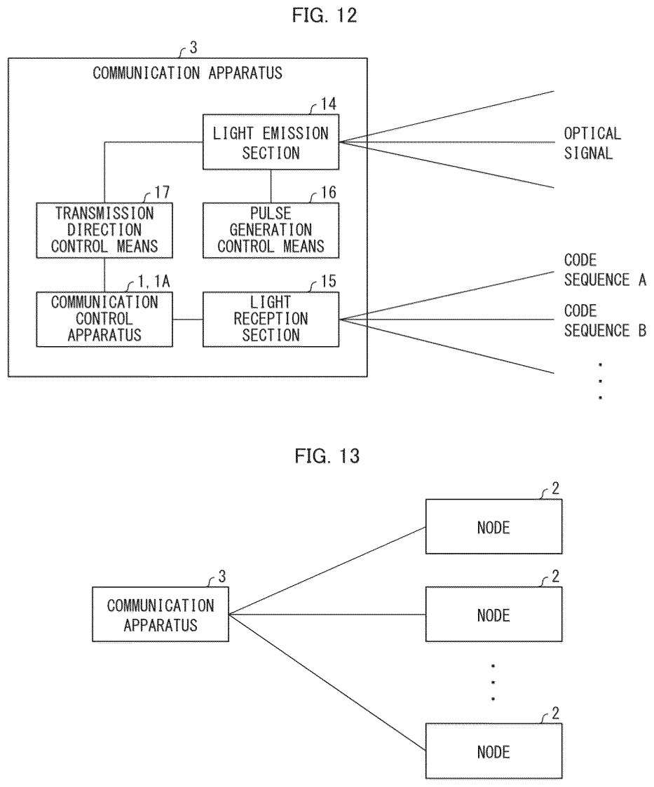

The following description will discuss a configuration of a communication apparatus 3 with reference to FIG. 12. FIG. 12 is a block diagram illustrating the configuration of the communication apparatus 3. As illustrated in FIG. 12, the communication apparatus 3 in accordance with the present example embodiment includes a light emission section 14, a light reception section 15, a pulse generation control means 16, and a transmission direction control means 17, in addition to the communication control apparatus 1 as described in the first example embodiment or the communication control apparatus 1A as described in the second example embodiment.

### Light Emission Section

The light emission section 14 repeatedly emits an optical signal in a predetermined cycle. The light emission section 14 in accordance with the present example embodiment emits a first optical signal at an arbitrary timing. As illustrated in FIG. 9, the light emission section 14 emits a second optical signal after a lapse of a predetermined period Ta after the first optical signal has been emitted. The predetermined period Ta is set to a time obtained by adding a pulse width Tp of an optical signal to a time which is an integral multiple Na of a sequence length TL of a code sequence. Similar to the second optical signal, the light emission section 14 emits an n-th (n=3 . . . ) optical signal after a lapse of the predetermined period Ta after an (n−1)th optical signal has been emitted. The light emission section 14 repeatedly emits an optical signal the number of times (Np times) which is an integral multiple of a number obtained by dividing the sequence length TL of the code sequence by the pulse width Tp of the optical signal. In a case where the sequence length is indivisible by the pulse width, the light emission section 14 assumes, as the above number of times (Np times), an integral multiple of a number obtained by rounding off a number obtained by dividing the sequence length by the pulse width of the optical signal.

The communication control apparatus 1 is not synchronized with the nodes 2. Therefore, the optical signal does not necessarily reach the node 2 at the same time as the timing at which the modulation action of the node 2 changes over to the next cycle (i.e., a partial sequence which is reflected first is not necessarily a partial sequence starting from the beginning). Therefore, the light emission section 14 in accordance with the present example embodiment repeatedly emits an optical signal Np×n times (n is an integer of 2 or more), as illustrated in FIGS. 9 and 10. Thus, even in a case where an optical signal reaches the node 2 in the middle of a modulation action in one cycle and a partial sequence which is first reflected from the node 2 is a halfway part of the code sequence, a partial sequence from the beginning to the halfway part of the code sequence is reflected during a modulation action in the next cycle. Therefore, the acquisition means can reliably acquire the entire single code sequence.

### Pulse Generation Control Means

The description returns to FIG. 12. The pulse generation control means 16 controls the light emission section 14 so that the light emission section 14 emits an optical signal having a pulse width set in advance. The pulse generation control means 16 can adjust intensity of an optical signal in accordance with a setting operation carried out by a user. Moreover, the pulse generation control means 16 can adjust a pulse width of an optical signal in accordance with a setting operation carried out by a user.

### Transmission Direction Control Means

The transmission direction control means 17 controls the light emission section 14 so that the light emission section 14 is oriented in an intended direction (to emit an optical signal in the intended direction) in accordance with, for example, an operation by a user. The transmission direction control means 17 controls the light emission section 14 so that the light emission section 14 is oriented toward an identified node based on information pertaining to the node identified by the communication control apparatus 1 or 1A.

### Light Reception Section

The light reception section 15 receives a plurality of code sequences which have been reflected from respective nodes 2.

### (Example Advantage of Communication Apparatus 3)

According to the communication apparatus 3 described above, an example advantage similar to that of the communication control apparatus 1 in accordance with the first example embodiment can be brought about. That is, the communication apparatus 3 brings about an example advantage of making it possible to identify each node 2 while suppressing power consumption even in a case where a plurality of nodes 2 which are free space optical communication partners are located relatively far away. As described above, the communication apparatus 3 employs the configuration of including a light emission section and a light reception section (where a communication control apparatus is integrated with a means for actually carrying out communication). Therefore, the communication apparatus 3 brings about an example advantage of making it possible to easily identify a node 2 without separately preparing an apparatus which emits an optical signal and an apparatus which receives a code sequence, in addition to the communication control apparatus 1 or 1A.

### Fourth Example Embodiment

The following description will discuss a fourth example embodiment, which is an example of an embodiment of the present invention, in detail, with reference to the drawings. The same reference numerals are given to constituent elements having the same functions as those described in the foregoing example embodiments, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Communication System)

The following description will discuss a configuration of a communication system 100, with reference to FIG. 13. FIG. 13 is a block diagram illustrating the configuration of the communication system 100. As illustrated in FIG. 13, the communication system 100 in accordance with the present example embodiment includes a plurality of nodes 2 described in the first and second example embodiments, and a communication apparatus 3 similar to that in the third example embodiment. The communication system 100 may include a communication control apparatus 1 or 1A which is similar to that in the first or second example embodiment, instead of including the communication apparatus 3.

### Communication Apparatus

The communication apparatus 3 communicates with a node 2 which has been identified by the communication control apparatus 1 or 1A. The communication apparatus 3 communicates, through free space optics (FSO) communication, with the node 2 which has been identified by the communication control apparatus 1.

### (Example Advantage of Communication System)

The communication system 100 described above employs the configuration of including the communication control apparatus 1 or 1A in accordance with the first or second example embodiment. That is, in a case where a pulse width of an optical signal is shorter than a sequence length of a code sequence, the communication control apparatus 1 or 1A acquires the code sequence in a plurality of portions. Therefore, the communication system 100 in accordance with the present example embodiment brings about an example advantage of making it possible to identify each node 2 while suppressing power consumption even in a case where a plurality of nodes 2 which are free space optical communication partners are located relatively far away.

### [Software Implementation Example]

Some or all of the functions of each of the communication control apparatuses 1 and 1A (hereinafter referred to as “each of the apparatuses”) may be implemented by hardware such as an integrated circuit (IC chip), or may be implemented by software.

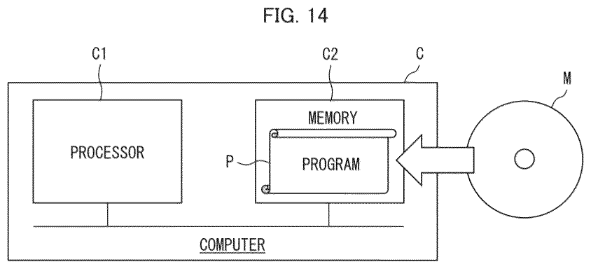

In the latter case, each of the apparatuses is implemented by, for example, a computer that executes instructions of a program that is software implementing the foregoing functions. FIG. 14 illustrates an example of such a computer (hereinafter, referred to as “computer C”). FIG. 14 is a block diagram illustrating a hardware configuration of the computer C which functions as each of the apparatuses.

The computer C includes at least one processor C1 and at least one memory C2. The memory C2 stores a program P for causing the computer C to operate as each of the apparatuses. The processor C1 of the computer C retrieves the program P from the memory C2 and executes the program P, so that the functions of each of the apparatuses are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded in a case where the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present disclosure includes techniques described in supplementary notes below. Note, however, that the present invention is not limited to the techniques described in supplementary notes below, but may be altered in various ways by a skilled person within the scope of the claims.

### (Supplementary Note 1)

A communication control apparatus for identifying a plurality of nodes each of which is configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received, the communication control apparatus including: an acquisition means for acquiring a code sequence which has been reflected by any of the plurality of nodes; a demodulation means for demodulating the code sequence using any of the spreading codes; and an identification means for identifying, among the plurality of nodes, a node that corresponds to the spreading code which has been used in the demodulation, in a case where a pulse width of the optical signal is shorter than a sequence length of the code sequence, the acquisition means acquiring a first partial sequence which is a part of the code sequence and has been generated while the node is receiving one optical signal, acquiring a second partial sequence which is a part of the code sequence, is continued from the first partial sequence, and has been generated while the node is receiving another optical signal, and generating the code sequence by joining the second partial sequence to an end of the first partial sequence.

### (Supplementary Note 2)

A communication apparatus including: the communication control apparatus according to supplementary note 1; a light emission section which repeatedly emits the optical signal in a predetermined cycle; and a light reception section which receives the code sequence, the predetermined cycle being set to a time obtained by adding the pulse width of the optical signal to a time which is an integral multiple of the sequence length.

### (Supplementary Note 3)

The communication apparatus according to supplementary note 2, in which: the light emission section repeatedly emits the optical signal the number of times which is an integral multiple of a number obtained by dividing the sequence length of the code sequence by the pulse width of the optical signal.

### (Supplementary Note 4)

The communication control apparatus according to any one of supplementary notes 1 through 3, in which: the acquisition means acquires a plurality of code sequences which have been reflected by the plurality of nodes, respectively; the demodulation means demodulates the plurality of code sequences using any of the spreading codes having patterns which differ for each of the plurality of nodes; the communication control apparatus further includes a second demodulation means for demodulating each of the plurality of code sequences using another spreading code which is different from the spreading code used by the demodulation means among the spreading codes having the respective patterns; and the communication control apparatus further includes a second identification means for identifying, among the plurality of nodes, a node which corresponds to that another spreading code used for demodulation by the second demodulation means.

### (Supplementary Note 5)

The communication control apparatus according to any one of supplementary notes 1 through 4, in which: each of the spreading codes is an optical orthogonal code.

### (Supplementary Note 6)

A communication system, including: a plurality of nodes each of which is configured to (i) repeat a modulation action for modulating received light into a code sequence using any of spreading codes having different patterns and (ii) reflect at least a part of the code sequence which has been generated by at least a part of the modulation action carried out while a pulsed optical signal is being received; and the communication control apparatus described in any one of supplementary notes 1, 4, and 5 or the communication apparatus described in supplementary note 2 or 3.

### (Supplementary Note 7)

A communication control program for causing a computer to function as the communication control apparatus according to supplementary note 1, the communication control program causing the computer to function as the acquisition means, the demodulation means, and the identification means.

### (Supplementary Note 8)

A communication control method for identifying a plurality of nodes each of which is configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received, the communication control method including: acquiring, by a computer, a code sequence which has been reflected by any of the plurality of nodes; demodulating, by the computer, the code sequence using any of the spreading codes; and identifying, by the computer, among the plurality of nodes, a node that corresponds to the spreading code which has been used in the demodulation, in a case where a pulse width of the optical signal is shorter than a sequence length of the code sequence, in the acquiring, the computer acquiring a first partial sequence which is a part of the code sequence and has been generated while the node is receiving one optical signal, acquiring a second partial sequence which is a part of the code sequence, is continued from the first partial sequence, and has been generated while the node is receiving another optical signal, and generating the code sequence by joining the second partial sequence to an end of the first partial sequence.

### (Supplementary Note 9)

The communication control method according to supplementary note 8, in which: the computer includes a light emission section which repeatedly emits the optical signal in a predetermined cycle, and a light reception section which receives the code sequence, the predetermined cycle being set to a time obtained by adding the pulse width of the optical signal to a time which is an integral multiple of the sequence length.

### (Supplementary Note 10)

The communication control method according to supplementary note 9, in which: the light emission section repeatedly emits the optical signal the number of times which is an integral multiple of a number obtained by dividing the sequence length of the code sequence by the pulse width of the optical signal.

### (Supplementary Note 11)

The communication control method according to any one of supplementary notes 8 through 10, in which: in the acquiring, the computer acquires a plurality of code sequences which have been reflected by the plurality of nodes, respectively; in the demodulating, the computer demodulates the plurality of code sequences using any of the spreading codes having patterns which differ for each of the plurality of nodes; the communication control method further includes demodulating each of the plurality of code sequences using another spreading code which is different from the spreading code used in the demodulating among the spreading codes having the respective patterns; and the communication control method further includes identifying, among the plurality of nodes, a node which corresponds to that another spreading code used for demodulation.

### (Supplementary Note 12)

The communication control method according to supplementary note 8, in which: each of the spreading codes is an optical orthogonal code.

### [Additional Remark 2]

The present disclosure includes techniques described in supplementary notes below. Note, however, that the present invention is not limited to the techniques described in supplementary notes below, but may be altered in various ways by a skilled person within the scope of the claims.

### (Supplementary Note 1)

A communication control apparatus including at least one processor, each of a plurality of nodes to be identified being configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received, the at least one processor carrying out an acquisition process of acquiring a code sequence which has been reflected by any of the plurality of nodes, a demodulation process of demodulating the code sequence using any of the spreading codes, and an identification process of identifying, among the plurality of nodes, a node that corresponds to the spreading code which has been used in the demodulation, in a case where a pulse width of the optical signal is shorter than a sequence length of the code sequence, in the acquisition process, the at least one processor acquiring a first partial sequence which is a part of the code sequence and has been generated while the node is receiving one optical signal, acquiring a second partial sequence which is a part of the code sequence, is continued from the first partial sequence, and has been generated while the node is receiving another optical signal, and generating the code sequence by joining the second partial sequence to an end of the first partial sequence.

Note that the communication control apparatus may further include a memory. In the memory, a program for causing the at least one processor to carry out the processes can be stored.

### (Supplementary Note 2)

A communication apparatus including: a communication control apparatus according to supplementary note 1; a light emission section which repeatedly emits the optical signal in a predetermined cycle; and a light reception section which receives the code sequence, the predetermined cycle being set to a time obtained by adding the pulse width of the optical signal to a time which is an integral multiple of the sequence length.

### (Supplementary Note 3)

The communication apparatus according to supplementary note 2, in which: the light emission section repeatedly emits the optical signal the number of times which is an integral multiple of a number obtained by dividing the sequence length of the code sequence by the pulse width of the optical signal.

### (Supplementary Note 4)

The communication control apparatus according to supplementary note 1, in which: in the acquisition process, the at least one processor acquires a plurality of code sequences which have been reflected by the plurality of nodes, respectively; in the demodulation process, the at least one processor demodulates the plurality of code sequences using any of the spreading codes having patterns which differ for each of the plurality of nodes; the at least one processor further carries out a second demodulation process of demodulating each of the plurality of code sequences using another spreading code which is different from the spreading code used in the demodulation process among the spreading codes having the respective patterns; and the at least one processor further carries out a second identification process of identifying, among the plurality of nodes, a node which corresponds to that another spreading code used for demodulation in the second demodulation process.

### (Supplementary Note 5)

The communication control apparatus according to supplementary note 1, in which: each of the spreading codes is an optical orthogonal code.

### REFERENCE SIGNS LIST

100: Communication system
1, 1A: Communication control apparatus
   11, 11A: Acquisition means
   12, 12A: Demodulation means
   12B: Second demodulation means
   13: Identification means
   13A: Second identification means
   14: Light emission section
   15: Light reception section
   16: Pulse generation control means
   17: Transmission direction control means
2: Node
   21: MRR
   22: Identification signal generation means
   23: Spreading code generation means
   24: Signal input control means
3: Communication apparatus
C1: Processor
C2: Memory
S1, S1A: Communication control method
   S11, S11A: Acquisition process
   S111: Determination process
   S112: Collective acquisition process
   S113: First part acquisition process
   S114: Second part acquisition process
   S115: Joining process
   S116: Additional part acquisition process
   S12, S12A: Demodulation process
   S12B: Second demodulation process
   S13: Identification process
   S13A: Second identification process
Ta: Predetermined cycle
Tp: Pulse width
TL: Sequence length

1. A communication control apparatus comprising at least one processor,
each of a plurality of nodes to be identified being configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received,
the at least one processor carrying out
an acquisition process of acquiring a code sequence which has been reflected by any of the plurality of nodes,
a demodulation process of demodulating the code sequence using any of the spreading codes, and
an identification process of identifying, among the plurality of nodes, a node that corresponds to the spreading code which has been used in the demodulation,
in a case where a pulse width of the optical signal is shorter than a sequence length of the code sequence, in the acquisition process, the at least one processor
acquiring a first partial sequence which is a part of the code sequence and has been generated while the node is receiving one optical signal,
acquiring a second partial sequence which is a part of the code sequence, is continued from the first partial sequence, and has been generated while the node is receiving another optical signal, and
generating the code sequence by joining the second partial sequence to an end of the first partial sequence.

2. A communication apparatus comprising:
a communication control apparatus recited in claim 1;
a light emission section which repeatedly emits the optical signal in a predetermined cycle; and
a light reception section which receives the code sequence,
the predetermined cycle being set to a time obtained by adding the pulse width of the optical signal to a time which is an integral multiple of the sequence length.

3. The communication apparatus according to claim 2, wherein:
the light emission section repeatedly emits the optical signal the number of times which is an integral multiple of a number obtained by dividing the sequence length of the code sequence by the pulse width of the optical signal.

4. The communication control apparatus according to claim 1, wherein:
in the acquisition process, the at least one processor acquires a plurality of code sequences which have been reflected by the plurality of nodes, respectively;
in the demodulation process, the at least one processor demodulates the plurality of code sequences using any of the spreading codes having patterns which differ for each of the plurality of nodes;
the at least one processor further carries out a second demodulation process of demodulating each of the plurality of code sequences using another spreading code which is different from the spreading code used in the demodulation process among the spreading codes having the respective patterns; and
the at least one processor further carries out a second identification process of identifying, among the plurality of nodes, a node which corresponds to that another spreading code used for demodulation in the second demodulation process.

5. The communication control apparatus according to claim 1, wherein:
each of the spreading codes is an optical orthogonal code.

6. A communication system, comprising:
a plurality of nodes each of which is configured to (i) repeat a modulation action for modulating received light into a code sequence using any of spreading codes having different patterns and (ii) reflect at least a part of the code sequence which has been generated by at least a part of the modulation action carried out while a pulsed optical signal is being received; and
a communication control apparatus recited in claim 1.

7. A communication system, comprising:
a plurality of nodes each of which is configured to (i) repeat a modulation action for modulating received light into a code sequence using any of spreading codes having different patterns and (ii) reflect at least a part of the code sequence which has been generated by at least a part of the modulation action carried out while a pulsed optical signal is being received; and
a communication apparatus recited in claim 2.

8. A non-transitory storage medium storing a communication control program for causing at least one processor to carry out:
an acquisition process of acquiring a code sequence which has been reflected by any of a plurality of nodes each of which is configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received;
a demodulation process of demodulating the code sequence using any of the spreading codes; and
an identification process of identifying, among the plurality of nodes, a node that corresponds to the spreading code which has been used in the demodulation,
in a case where a pulse width of the optical signal is shorter than a sequence length of the code sequence, the at least one processor, in the acquisition process, being caused to further carry out
a process of acquiring a first partial sequence which is a part of the code sequence and has been generated while the node is receiving one optical signal,
a process of acquiring a second partial sequence which is a part of the code sequence, is continued from the first partial sequence, and has been generated while the node is receiving another optical signal, and
a process of generating the code sequence by joining the second partial sequence to an end of the first partial sequence.

9. A communication control method, comprising:
acquiring, by at least one processor, a code sequence which has been reflected by any of a plurality of nodes each of which is configured to (i) repeat a modulation action for modulating received light into a code sequence using any of spreading codes having patterns that differ for each of the plurality of nodes and (ii) reflect at least a part of the code sequence which has been generated by at least a part of the modulation action carried out while a pulsed optical signal is being received;
demodulating, by the at least one processor, the code sequence using any of the spreading codes; and
identifying, by the at least one processor, among the plurality of nodes, a node that corresponds to the spreading code which has been used in the demodulation,
in a case where a pulse width of the optical signal is shorter than a sequence length of the code sequence,
in the acquiring, the at least one processor acquiring a first partial sequence which is a part of the code sequence and has been generated while the node is receiving one optical signal,
acquiring a second partial sequence which is a part of the code sequence, is continued from the first partial sequence, and has been generated while the node is receiving another optical signal, and
generating the code sequence by joining the second partial sequence to an end of the first partial sequence.
